(19) United States
(12) Patent Application Publication
(10) Pub. No.: US 2012/0298054 A1
(43) Pub. Date: Nov. 29, 2012

(54) HYDROXY GAS PRODUCTION SYSTEM WITH A DIGITAL CONTROL SYSTEM FOR AN INTERNAL COMBUSTION ENGINE

(76) Inventor: Dan Dinsmore, North Saanich (CA)

(21) Appl. No.: 13/575,954

(22) PCT Filed: Jan. 29, 2011
(86) PCT No.: PCT/IB2011/050401

§ 371 Date: Jul. 29, 2012

Related U.S. Application Data
(60) Provisional application No. 61/299,900, filed on Jan. 29, 2010.
(60) Provisional application No. 61/299,947, filed on Jan. 30, 2010.

(51) Int. Cl. F02B 43/10

(52) U.S. Cl. 123/3

(57) ABSTRACT

A hydroxy gas generator for an internal combustion engine is digitally controlled by a micro- controller and is installed in a vehicle. The invention senses vehicle RPM and uses a pulse width modulation signal of variable duty cycle with feedback to set the current to the electrolysis cell to one of three possible values. At zero RPM the current to the cell is zero. At an idle, a small amount of hydrogen is produced to aid in combustion but to prevent strain on the alternator. Above an idle, the system is running at full capacity to generate the maximum amount of hydrogen.

### TECHNICAL FIELD

This invention is in the field of internal combustion engines and in particular devices combined with internal combustion engines and specifically a hydroxy gas production system with a digital control system for internal combustion engines.

### BACKGROUND ART

The current transportation network around the world is extremely dependent on fossil fuels. With high prices and the limited quantities of oil, it is important to reduce consumption, lower expenses and prolong the life span of internal combustion technology, until a suitable alternative is found. It is also important to reduce emissions produced because of the negative effects on human health and global environment. The present invention seeks to tackle these issues.

### DISCLOSURE OF INVENTION

### Technical Problem

The present invention is an ‘on the fly’ hydroxy gas production system having a digital control system that has the ability to be integrated into diesel and gasoline combustion engines. By injecting hydroxy gas generated through electrolysis into the engine's air intake the harmful exhaust emissions are decreased and the burn efficiency is significantly increased. The result is a much cleaner more efficient running engine.

Prior art systems used an analog amplification circuit to control the current to the electrolysis cell. This system was limited to only one rate of hydrogen production which caused the alternator to be strained at lower RPMs and not used to its full potential at higher RPMs.

One objective of the invention is to produced a digital control amplification system using a microcontroller with multiple input/output and feedback controls to optimize the electrolysis production with respect to alternator power.

In one embodiment of the invention the vehicle crankshaft position sensor is used to measure the vehicle RPM and adjust the current to the electrolysis cell accordingly using a feedback loop in a software program.

In another embodiment of the invention various temperature sensors are incorporated to prevent failure of the amp and cell due to overheating and to prevent the electrolyte solution from freezing.

In one embodiment of the invention a float sensor is used to prevent the electrolyte solution from running dry.

In another embodiment of the invention a potentiometer is used as an interface to scale the current for different engine sizes.

Tests were conducted to determine the rate of hydrogen production at various electrolyte concentrations and at various currents and voltages. The results from these tests were used to determine the current that is needed to produce the required amount of hydroxy gas from an optimum electrolyte concentration.

In one embodiment of the invention the control system reads the vehicle RPM and uses a pulse width modulation signal of variable duty cycle with feedback to set the current to the electrolysis cell to one of three possible values. At zero RPM the current to the cell is zero. At an idle a small amount of hydrogen is produced to aid in combustion but to prevent strain on the alternator. Above an idle the system is running at full capacity to generate the maximum amount of hydrogen. At start-up the reservoir level and temperature are checked. If the reservoir is frozen, the system will not start up until it is above a certain temperature. If the reservoir is low, a warning signal is sent to the user interface on the dashboard. If at any point during operation one of the cell or amp temperature sensors goes out of range, the system is shut down and the user is notified by a visual display, until it is back in range.

The present invention includes a microcontroller to adjust the PWM duty cycle, as well as temperature and reservoir level sensors to provide feedback to the software program and microcontroller. Testing was done in order to determine the relation between solution concentration, current and the rate of hydrogen production. It was found that the relations between these parameters are relatively linear, and that solutions of lower concentrations were more efficient at producing hydrogen. The electrical design of the present invention has improved efficiency though faster switching, resulting in less heat generation. The selected sensors offer an acceptable degree of precision, and their performance has been verified through testing. The software of the present invention incorporates a calibration routine, to ensure accurate operation of the current sensor; temperature limits; a status light; engine speed ranges and corresponding current draws; and a feedback control loop to adjust the PWM duty cycle as needed. The system is designed to be reprogrammable, to allow future revisions of software to be updated, without removing the system from the vehicle.

### TECHNICAL SOLUTION

### Advantageous Effects

### Description of Drawings

FIG. 1 is a block diagram of one embodiment of the invention.

FIG. 1A is a diagram of the electrolytic cell of one embodiment of the invention.

FIG. 2 is a block diagram of another embodiment of the invention.

FIG. 3 is a block diagram of yet another embodiment of the invention.

FIG. 4 is a circuit diagram of one embodiment of the invention.

FIG. 8 is a graph of time required to produce 500 mL of hydroxy gas vs. [KOH].

FIG. 9 is a graph of hydroxy gas production rate vs. applied current to the cell.

FIG. 10 a software flow sheet of one embodiment of the invention.

### BEST MODE

The present invention is a hydrogen gas injection system to improve the performance of internal combustion engines by injecting hydrogen-oxygen (hydroxy) gas. The hydrogen-oxygen gas is produced by electrolysis of a potassium-hydroxide solution (KOH and H2O). The system then injects the hydrogen-oxygen gas into the engine's air intake where it mixes with the existing air-fuel mixture. The addition of hydrogen to the fuel mixture allows the engine combustion cycle to progress more rapidly resulting in a more complete and efficient combustion. This in turn reduces fuel consumption and harmful emissions as well as improving engine power output.

The present invention has the advantage of improved controller circuits with the addition of a microcontroller and software for optimizing hydrogen production.

In one prior art embodiment of the invention , the control system uses an open-loop system that uses an analog pulse-width modulation (PWM) circuit to regulate the constant-current electrolysis of the potassium-hydroxide (KOH) solution based on preset values. With this system the production of hydrogen gas is constant and is optimized for minimum emissions at certain engine speed. This prior art embodiment has the following deficiencies, namely, the lack of a sophisticated control scheme, the lack of a system feedback scheme, the unavailability of hydrogen production data and the lack of system versatility.

The lack of a sophisticated control and feedback in the prior art system forces the use of static
hydrogen production rates to prevent malfunction of the electrolytic cell. The use of a constant production rate results in the hydrogen being used inefficiently at lower engine speed or being insufficient at higher engine RPM (revolutions per minute). This also puts unnecessary strain on the electrical system when the engine is at idle for long periods of time. A further limitation of the prior art system is a lack of versatility. The system needs to be recalibrated if a different concentration of electrolyte is used, as is necessary for operation in colder ambient temperature.

To resolve the four main deficiencies an improved system electronic and control system is included in the present invention comprising a microcontroller with several sensors (such as temperature, RPM, electrolyte concentration, water level) is implemented to provide a more dynamic, versatile and efficient system. The micro- controller also solves the problem of lack of performance data on hydrogen production rates and KOH solution concentrations

For invention operation in sub-zero temperatures two solutions were found that overcame the freezing problem: (1) add alcohol into the KOH solution; and, (2) increase the KOH concentration to lower the freezing point. Increasing the KOH concentration is the better choice because alcohol added to the system will break down over time due to the electrolysis reaction. Additionally, it is problematic to monitor alcohol levels. Increasing KOH concentration is the simpler solution since having only one compound in the solution is easier to control and analyze. The freezing point of KOH drops as the KOH concentration increases from zero to 30.8 weight percent (wt %) of KOH salt. The lowest possible liquid temperature of KOH solutions was found to be −65.2° C. when the concentration is at 30.8 wt %. Since temperatures below −65.2° C. are extreme and rare, the electrolytic cell optimized with KOH concentrations from 0 to 30 wt % allowing the invention to function almost anywhere.

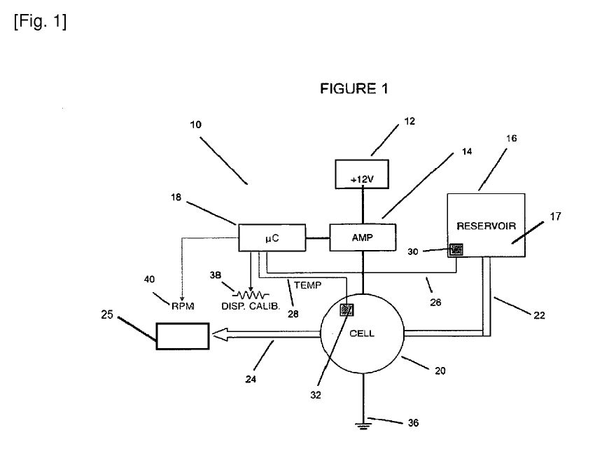

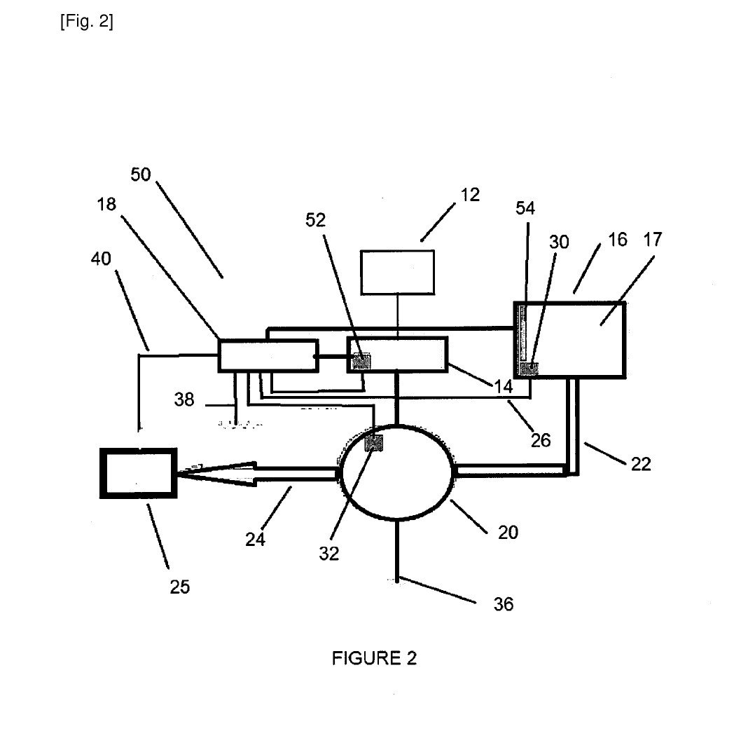

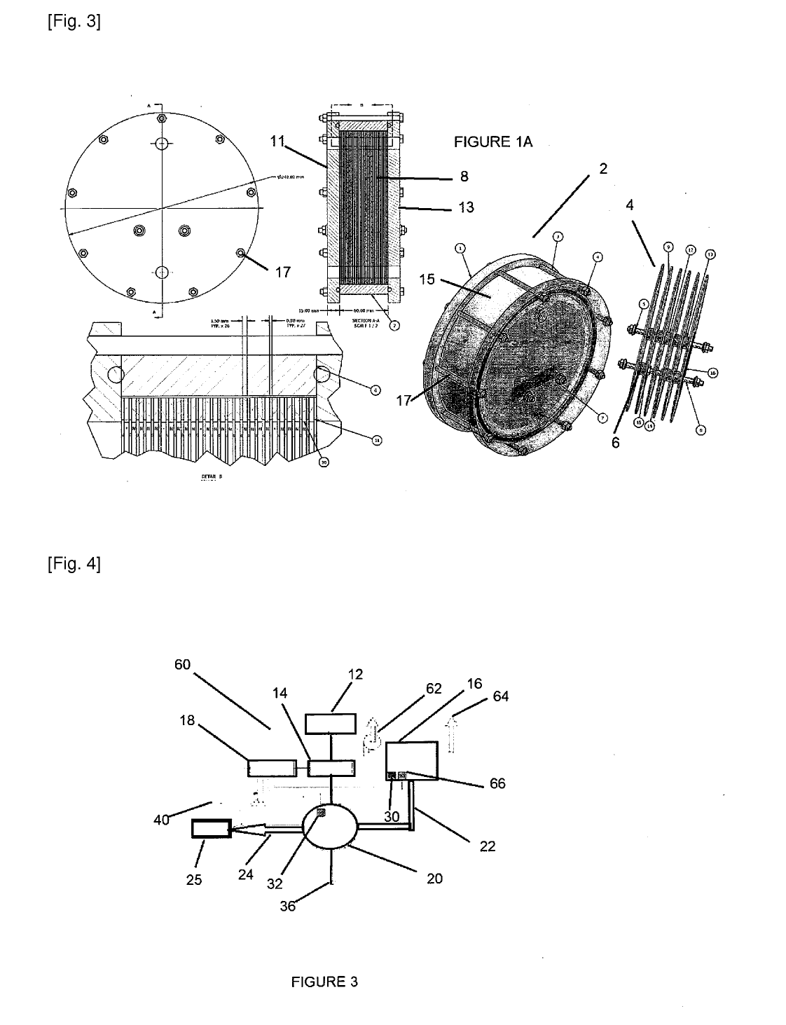

Referring to FIG. 1, there is shown one embodiment of the invention 10 for generating hydroxy gas comprising a power source 12 comprising a 12 VDC battery that would normally power an internal combustion engine 25 in a vessel or motor vehicle. The battery 12 is electrically connected to an amplifier 14 which provides a pulse width modulated current to the electrolytic cell 20. The amplifier 14 is controlled by a software driven microcontroller 18 which provides a control signal to the amplifier 14 which provides a pulse width modulated current to the cell 20 for controlling the reaction within the electrolytic cell 20. A reservoir 16 provides a source of electrolyte 17 as a feedstock for the electrolytic cell 20. The reservoir is connected by conduit 22 to provide a steady flow of electrolyte to the electrolytic cell 20. The electrolytic cell operates to produce hydroxy gas which is carried by conduit 24 to the fuel intake of an internal combustion engine 25. The cell is electrically grounded at 36. The microcontroller 18 has a number of sensors. Sensor 30 senses the temperature of the electrolyte 17 in the reservoir 16 to prevent freezing. Sensor 32 measures the temperature of the electrolytic cell 20 to prevent overheating. Sensor 40 measures the RPM of the internal combustion engine 25 so that the electrolytic cell and gas production can be synchronized to engine load. The microcontroller also includes a calibration element 38 and a display interface.

Referring to FIG. 1A, the present invention relies upon a rugged stainless steel electrolyzer cell 2 comprising a plurality of stainless steel plates 4 separated by gaskets 6. The cell is heat resistant and has no moving parts. Preferably the cell is circular and compact with a diameter of about 240 mm and a thickness of about 90 mm.

In one embodiment of the invention, the cell comprises a plurality of stainless steel circular plates in a stacked relationship 8. The plates are separated by a suitable insulating gasket comprising material such as nylon. The plates are sandwiched between two nylon end caps 11 and 13. A CPVC collar 15 is wrapped around the outer surface of the cell. The end caps are fastened together by a plurality of steel bolts 17 so that the end caps fit over the collar forming an housing that is virtually impervious to environmental penetration.

Referring to FIG. 2 there is shown another embodiment of the invention 50 wherein the reservoir 16 includes a temperature sensor 30 to prevent freezing and a level sensor 54 to monitor electrolyte levels. The electrolytic cell 30 is powered by battery 12 and grounded at 36 and includes a temperature sensor 32 to monitor cell temperature. The amplifier 14 is connected to battery 12 to provide a suitable pulse modulated voltage to cell 20. The cell the includes a second temperature sensor to monitor amplifier temperature to prevent overheating. Electrolyte feed stock 17 is feed to the electrolytic cell 20 by conduit 22. Hydroxy gas produced by the electrolytic cell is transported by conduit 25 to the fuel intake of internal combustion engine 25. Microcontroller 18 receives the inputs from sensors 30, 54, 32, 52 and the engine RPM sensor 40. The microcontroller 18 also includes the calibration input 38.

Referring now to FIG. 3 there is shown another embodiment of the invention 60. Additional sensor 66 is included to measure the concentration of KOH in reservoir 16. The fluid level within the reservoir could also be included. The reservoir includes a heating system 62 and 64 to ensure that the feedstock is maintained at a proper temperature.

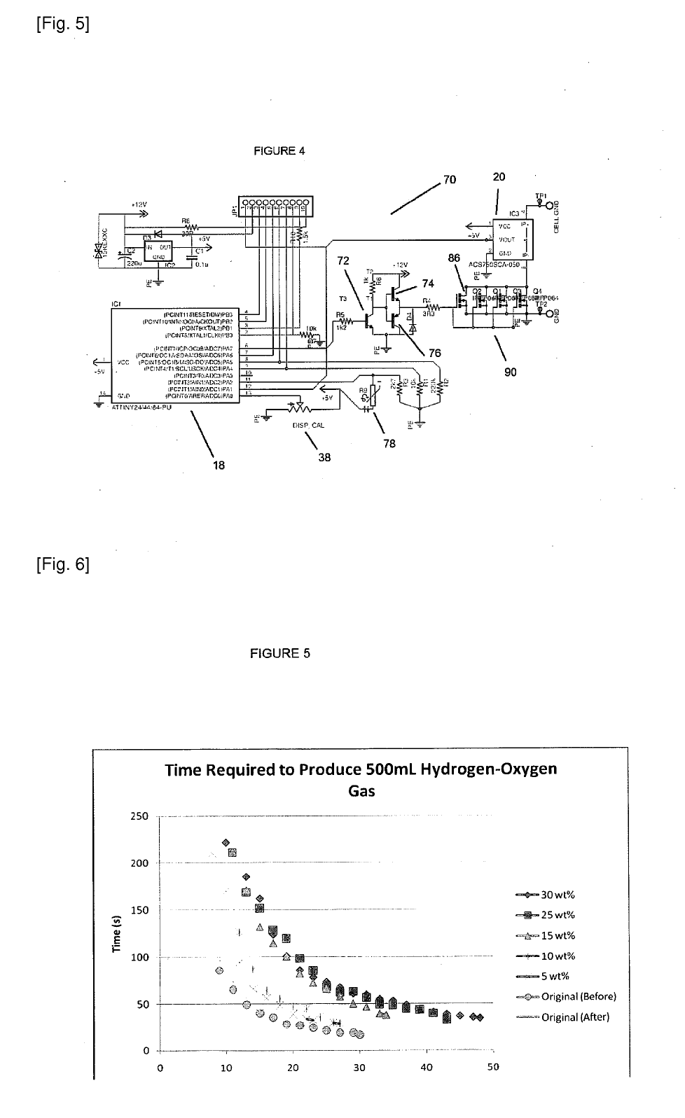

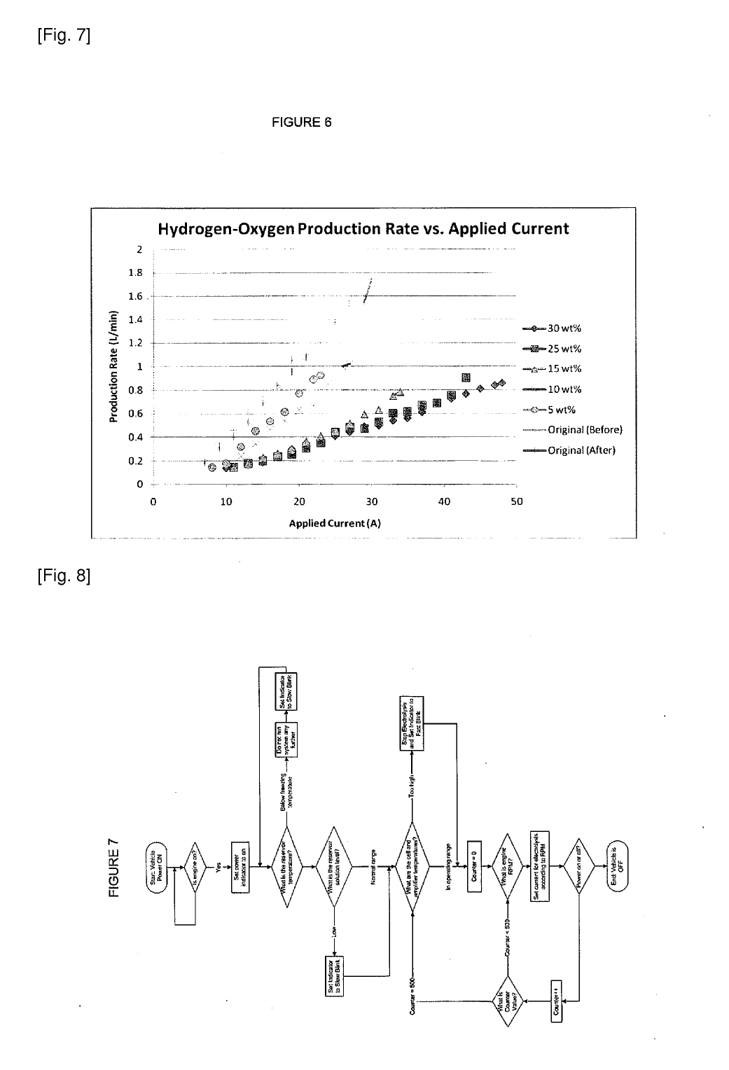

Referring to FIG. 4, there is shown a complete schematic 70 for one embodiment of the present invention. In the preferred embodiment of the invention there is a feedback circuit for each of the various different sensors in the system. In the embodiment of the invention shown in the schematic there are three thermistors 72, 74 and 76 used to monitor the temperature of the fluid reservoir 16, the electrolytic cell 20, and the temperature of the amplifier 14. A potentiometer 78 is included to serve as a calibration setting for the system. A float switch 80 is included in the electrolyte reservoir 16 to monitor the reservoir level. Furthermore, there is an input 82 from the vehicle internal position sensor 84. The present invention relies upon an embedded solution for current measurement to further reduce costs and overall footprint. An array 86 of four power transistors set in parallel are used to achieve the high-current PWM control. These transistors are driven by the microcontroller 18 through a totem pole circuit 90 to ensure rapid switching and minimal power losses.

The thermistors selected for the preferred embodiment of the present invention can be used in three embodiments of the invention. The minimum thermistor operating temperature was selected to be −40° C., corresponding to a situation where the reservoir has been subjected to freezing conditions. The maximum operating temperature was selected to be 125° C., corresponding with the maximum temperature of several of the integrated components. The thermistors have a 50 kΩ resistance at 25° C., and have a non-linear response. The thermistors for this application are NTSD1WD503FPB30 manufactured by muRata Electronics. Each thermistor provides feedback to the microcontroller, allowing it to respond when a threshold temperature has been reached. For the thermistors of the present invention to maintain extremely accuracy at all temperature values a simple voltage divider circuit is used with a static resistor value calculated to maximize the sensitivity of the thermistor around an operating point.

Cell temperature sensor needs to be accurate just below 100° C. A resistor value of 10 kΩ provides high sensitivity.

The reservoir temperature sensor needs to be accurate around the freezing point of water. By selecting R to be 220 kΩ, the reservoir temperature sensor would be very sensitive around this temperature.

The microcontroller of the present invention has at least five analog inputs: three for the temperature sensors, one for the current sensor, and one for the calibration potentiometer. The microcontroller will also require several digital inputs and outputs: an input from the engine's internal crankshaft position sensor, an input from the float valve and multiple outputs for indicator lights on the vehicles dashboard. The microcontroller is also capable of producing a pulse-width modulated (PWM) output to control the current flowing through the electrolytic cell.

In the preferred embodiment of the invention a microcontroller produced by Atmelis used.

The microcontroller is an Atmel ATtiny24A having 12 I/O pins, a 10-bit ADC with eight single-ended inputs, and two timers, one of which will generate the required PWM signal.

Current sensing is integrated directly into the circuit to avoid problems associated with shunt resistors such as fluctuating readings and the requirement for additional filtering. The current sensor is capable of measuring up to 70 amperes. The sensor output is an analogue voltage proportional to the current. In a preferred embodiment an ACS758LCB-100B-PFF-Tsensor from Allegro Microsystems is used. This sensor relies upon the Hall Effect to measure current flow through the high power side of the circuit. The sensor is capable of withstanding an over-current of 600 A for a duration of 1 second at 150° C. The output is reasonably linear with a maximum deviation of 1.25% at 100 A. The sensitivity of the sensor is 20 mV/A at 25° C. The variation in sensitivity can be accounted for based on the measured temperature.

A voltage regulator for the present invention comprises a standard LM7805. The voltage regulator outputs a constant 5 Vdc to supply the low power portion of the circuit. The regulator is filtered with over-size capacitors to produce the cleanest signal possible given the fluctuating nature of the vehicle's electrical system. The LM7805 voltage regulator selected has a maximum input voltage of 35 Vdc. In order to protect the regulator from transient voltage spikes, due to the unstable nature of the vehicles alternator, a 1.5KE20A Transient Voltage Suppression Diode paired with a 220 g capacitor were placed in parallel with the voltage regulator input.

The MOSFETs of the preferred embodiment of the present invention are IRFP3306PBF manufactured by International Rectifier. Four MOSFETs are used in parallel, to both function as a backup, and reduce the heat generated from switching the high current.

In order to ensure that the system will behave in a predictable manner, the maximum error associated with any of the sensors needs to be determined. The ADC system that the microcontroller uses has the option of running at its full resolution of 10 bits, or in a decreased mode of 8 bits. The 8-bit mode is simpler to implement in code, so it will be chosen if possible.

QI8bit=5/(28−1)=0.0196V QI10bit=5/(210−1)=0.0049V

The smallest change in voltage that can be detected with the ADC in 8-bit mode is about 20 mV, whereas the 10-bit mode can resolve to about 5 mV.

When considering the 2.7 kΩ resistor, with the controller thermistor at 125° C., the value of RT is 1.374 kΩ, and the output voltage is 3.31V, when a 5V source is used.

If the ADC value were off by 20 mV, the resistance would be calculated as 1.354 kΩ.

This corresponds to a temperature of 124° C., or a 1° C. error. When considering the 220 kΩ resistor, with the reservoir thermistor at 0° C., the value of RT is 172.393 kΩ, and the output voltage is 2.80V, when a 5V source is used. If the ADC value were off by 20 mV, the resistance would be calculated as 170.07 kΩ. This corresponds to a temperature of −0.29° C., or a 0.3° C. error.

The current sensor, as described above, has a sensitivity of 20 mV/A. When coupled with the ADC error of 20 mV, this corresponds to an error of 1A. From the magnitude of the current sensor error, it has been determined that the 10-bit precision will be used for the project.

Testing

The electrolysis system of the present invention has a variable production rate and can operate in different ambient temperatures. The current sensor output voltage and hydrogen-oxygen production rates were recorded for 5 wt % to 30 wt % KOH solutions. This data was used as an index for the microcontroller to set the system's hydrogen production rate in different scenarios.

Referring to FIG. 5 and FIG. 6, the setup used to test the gas production rates includes a gas-volume measuring device and the existing system hardware with the constant-current PWM controller replaced by a high power test circuit and several lab apparatuses. The gas-volume meter consists of clear plastic tubing and bottle with markings of different volumes. The high power test circuit consists of a current sensor and four MOSFETs connected in parallel, mounted on a heat sink. A fan was also added to provide extra cooling for the MOSFETs. The lab equipment used includes a power supply, a function generator and a voltmeter. The power supply was connected to provide power to the current sensor and the fan. The function generator was used to simulate the PWM signal generated by a microcontroller to control the MOSFET gates and the voltmeter was used to measure the output voltage from the current sensor, which was then used to calculate the current draw.

For the testing, the system was run with the function generator set at 50 Hz and generating a square wave. Then, by controlling the function generator's duty cycle, which varied from 20 to 80 percent, the current and gas production rate were varied. To measure the current applied, a reference voltage from the current sensor was read with the multi-meter while the system was off and then when the system was running, the change in voltage were recorded and related to a corresponding current value. To measure the amount of hydrogen produced, system was run and timed until the bottle was filled to a set volume of hydrogen-oxygen gas. This was then repeated for multiple current values and different concentrations of KOH solution.

Six solutions with different KOH concentration were tested. Five solutions had set concentrations of 5, 10, 15, 25, and 30 wt %. The recorded data from the set concentrations was used as parameters for programming the microcontroller and determine validity of the data trends because tap water was used to make the set concentration solutions and could lead to discrepancies with filtered water solutions.

In the tests, the time was recorded for the production of 250 mL or 500 mL of hydrogen-oxygen gas. For low applied currents, the production rate was extremely slow and to reduce testing times, the production was timed for 250 mL of gas. At high currents, the production rate becomes significantly faster and the volume was increased to 500 mL, to reduce human errors in the recorded time (i.e. slow reaction). FIG. 5 below shows the amount of time it takes to produce 500 mL of hydrogen-oxygen gas for the different applied currents and concentrations.

From the test results, the production rates were calculated and plotted, as seen in FIG. 6. It was found that lower KOH concentrations require less current to produce the same volume of hydrogen-oxygen gas. For lower concentrations, i.e. 5 or 10%, draws about 25 amps to produce 1 litre of hydrogen-oxygen gas per minute, while for high concentrations, the cell draws up to 50 amps for the same production rate. An explanation for this result would be because having higher concentration, the solution is more conductive and can allow more current to pass through easily. At lower concentrations, the higher resistance will result in more energy dissipated by splitting water into hydrogen and oxygen gas.

The electrolytic cell could achieve production up to 3 litres per minute for lower concentrations. Therefore, the recorded data was extrapolating to estimate the current draw for production up to 3 litres per minute. The equations used for extrapolation were second-order polynomial equations found using MS Excel. To check the validity of the extrapolated data, random scenarios were tested (different concentrations and applied currents) and compared with the data. The experimental results were found to be consistent with the extrapolations and eliminated the need to conduct further testing.

Software Design

Referring now to FIG. 7, the system was designed to produce hydrogen at three different rates depending on the engine RPM. The first hydrogen production rate was zero when the engine RPM is zero but the system is still getting power (engine is in Auxiliary Mode). The second rate was for engine idle. The hydrogen production rate is enough to aid in combustion, but will not strain the alternator. Above idle, the hydrogen production rate was set to a maximum value that the alternator was able to supply. The rate of hydrogen production can be controlled by the amount of current applied to the electrolytic plates, as discussed above. The current software revision would not take the production and concentration data into account.

There are a number of safety features that have also been incorporated into this design: temperature sensors on the cell, amp, and reservoir; and a reservoir level sensor.

These features have been categorized as either static or dynamic, depending on how frequently they are expected to change.

Static parameters are variables that only need to be read by the controller during start up. The static variables are the reservoir level and reservoir temperature. The reservoir solution level was determined initially during start up. If the reservoir is low, the system will continue running but will display a warning to the driver. The reservoir temperature was also set to be read at start up. If the temperature is out of range, (meaning the reservoir is frozen) the system will not start. The sensor will be monitored continuously until the temperature is above freezing, then the system will start.

The dynamic parameters are the variables that will change depending on environment conditions and the state of the system. These variables include engine RPM, current draw, cell temperature, and microcontroller temperature. Since these variables are susceptible to constant changes, they must be monitored frequently. At any RPM the microcontroller will control the current to one of the three predetermined values that will produce the desired amount of hydrogen. A feedback loop was integrated by constantly measuring the current and comparing it to the ideal value and adjusting the PWM duty cycle as needed. If all temperature sensors are in range and the reservoir is not empty, the system will produce a PWM current based on the engine RPM.

The current sensor was monitored and the duty cycle was updated every millisecond.

The crank position sensor and temperature sensors were monitored and the RPM value was updated every second. If the cell and amplifier temperatures are out of range, the system will be shut down until the temperatures are back in range.

1. A hydroxy gas production system with a digital control system for an internal combustion engines comprising:
a. an hydroxy gas generator for production of said hydroxy gas;
b. a gas injection system for delivering the hydroxy gas into a fuel intake of said internal combustion engine;
c. a pulse width modulated power source providing power to said hydroxy gas generator;
d. said digital control system comprising a microcontroller for controlling the hydroxy gas generator as a function of the status of the internal combustion engine; and,
e. an operator interface for visual determination of the status of the hydroxy gas production system.

2. The system of claim 1 wherein the hydroxy gas generator comprises an at least one electrolytic cell for converting a feedstock into the hydroxy gas.

3. The system of claim 2 wherein said at least one electrolytic cell comprises a body for containing a predetermined volume of said feedstock, a plurality of conductive plates disposed in a stacked relationship within said body and immersed within the feedstock; a positive electrode connected to a plurality of positively charged conductive plates, a negative electrode connected to a plurality of negatively charged plates; an intake port for receiving a replenishing source of the feedstock; an outlet port for releasing hydroxy gas; and, a plurality of spaces between each conductive plate so that they are electrically isolated from each other.

4. The system of claim 3 wherein the feedstock is an aqueous solution of KOH.

5. The system of claim 4 wherein said aqueous solution of KOH is between 0% and 30% of KOH salt.

6. The system of claim 5 wherein the aqueous solution of KOH is between 5% and 10% of KOH salt.

7. The system of claim 2 wherein the feedstock is stored in a reservoir in fluid communication with said at least one electrolytic cell.

8. The system of claim 7 wherein said reservoir includes a temperature sensor in electrical communication with said microcontroller for monitoring feedstock temperature

9. The system of claim 8 wherein the reservoir includes a level sensor in electrical communication with the microcontroller for monitoring feedstock level.

10. The system of claim 9 wherein said level sensor is a float switch.

11. The system of claim 10 wherein the reservoir includes a heater for maintaining feedstock temperature above a freezing point.

12. The system of claim 1 wherein said gas injection system comprises a gas conduit from the at least one electrolytic cell to said fuel intake.

13. The system of claim 12 wherein said gas conduit further includes a gas dryer and a moisture separator.

14. The system of claim 13 wherein the gas conduit further includes a hydroxy gas storage tank and an expansion tank disposed between said gas dryer and the at least one electrolytic cell.

15. The system of claim 1 wherein said pulse width modulated power source comprises a 12 VDC battery and a pulse width modulator.

16. The system of claim 15 wherein the pulse width modulator comprises at least four MOSFETs and a suitable heat sink and is controlled by the microcontroller.

17. The system of claim 16 wherein the pulse width modulator generator generates a pulse width modulation signal to the at least one electrolytic cell and a feedback signal to the microcontroller, wherein said pulse width modulation signal has a variable duty cycle, and wherein the microcontroller sets said variable duty cycle to zero amps when the internal combustion engine is not running.

18. The system of claim 17 wherein said pulse width modulated power source includes a temperature sensor in electrical communication with the microcontroller for detecting an overheat condition.

19. The system of claim 1 wherein the internal combustion engine includes an RPM sensor for detecting engine RPM electrically connected to the microcontroller wherein said RPM sensor measures RPM from a crankshaft position sensor.

20. The system of claim 1 wherein the microcontroller includes a plurality of system inputs from a plurality of sensors comprising at least the following sensors: a feedstock temperature sensor, a feedstock level sensor, an electrolytic cell temperature sensor, a pulse width modulated power source temperature sensor, a calibration potentiometer sensor, a electrolytic cell current sensor and an engine RPM sensor.

21. The system of claim 20 wherein said feedstock temperature sensor, said electrolytic cell temperature sensor and said pulse width modulated power source temperature sensors comprise thermistors having an operating range between minus 40° C. and plus 125° C. and having a feedback circuit to the microcontroller so that the microcontroller can respond when said operating range has been exceeded.

22. The system of claim 21 wherein said electrolytic cell current sensor can measure at least 70 amps and can withstand an overcurrent of 600 amps for one second at 150° C.

23. The system of claim 22 further including a voltage regulator generating 5 VDC for power to the microcontroller and said plurality of sensors.

24. The system of claim 1 wherein the microcontroller includes a software program.

25. The system of claim 24 wherein said software program controls the rate of hydroxy gas production.

26. The system of claim 25 wherein the software program controls the rate of hydroxy gas production at three rates comprising:
production when the engine RPM sensor records zero RPM, production when the engine RPM sensor records an idle RPM and maximum production rate when the engine RPM sensor records an RPM above said idle RPM.

27. The system of claim 26 wherein the software program monitors a plurality of static parameters comprising the feedstock level and the feedstock temperature.

28. The system of claim 27 wherein the software program monitors a plurality of dynamic parameters comprising the engine RPM, the electrolytic cell current, the electrolytic cell temperature and the microcontroller temperature.

29. The system of claim 28 wherein the software program further monitors electrolytic concentration within the reservoir.

30. The system of claim 1 wherein said operator interface provides a readout of electrolytic cell current and reservoir level.
